(19) United States
(12) Patent Application Publication
(10) Pub. No.: US 2025/0220355 A1
(43) Pub. Date: Jul. 3, 2025

(54) LOUDSPEAKER

(71) Applicant: Tymphany HK Limited

(72) Inventors: Andrew Trippier Holt, Taipei City (TW); Chang-qi Wang, Taipei City (TW); Mei-cong Chen, Taipei City (TW); Yue Zhao, Taipei City (TW)

(21) Appl. No.: 18/964,198

(22) Filed: Nov. 29, 2024

Related U.S. Application Data
(60) Provisional application No. 63/615,463, filed on Dec. 28, 2023.

(51) Int. Cl. H04R 9/04; H04R 1/02; H04R 7/18; H04R 9/02; H04R 9/06

(52) U.S. Cl. CPC H04R 9/043; H04R 1/025; H04R 7/18; H04R 9/025; H04R 9/06

(57) ABSTRACT

A loudspeaker includes a chassis, a cup, a voice coil and a spider. An outer edge of the spider is provided towards the bottom end of the cup and the inner edge of the spider is connected to a U-iron or T-yoke. The cup has a top end directly facing a diaphragm. The voice coil, the spider and at least a portion of the cup are disposed within the chassis. There is at least a window or opening is provided in the side wall of the chassis to expose a portion of the bottom end of the cup to allow increased size of the voice coil and the spider.

### CROSS REFERENCE TO RELATED APPLICATIONS

This application claims priority of U.S. Provisional Application No. 63/615,463 filed on Dec. 28, 2023 under 35 U.S.C. §119(e), the entire contents of all of which are hereby incorporated by reference.

### FIELD OF THE INVENTION

This invention relates to a loudspeaker, especially to a loudspeaker having a long-stroke driver with a high-aspect ratio suspension.

### BACKGROUND OF THE INVENTION

Traditional loudspeakers use a round spider (suspension element), typically circumferentially enclosing the voice coil. Generally, such loudspeakers are circular. Modern audio systems often require more integrated bass, particularly subwoofer performance, within a single product without a separate subwoofer enclosure and its associated electronics. This is typically the case when form factor is important and prioritized above other aspects of system design. Typical examples include monitor/display subwoofers, all-in-one sound bars, and slim form factor network audio products, such as those incorporating WIFI and Bluetooth. Such systems often require high aspect ratio (non-circular) form factors, coupled with high driving power, to deliver a strong bass as possible in a confined space, particularly in products with limited height. High aspect ratio, long stroke drivers optimized for smaller products face multiple design challenges. They require high-force driving systems, necessitating powerful drivers and voice coils, as well as a large moving mass to function effectively in a relatively small volume. Such a high force (beta) driver can only be realised with certain minimum diameters of voice coil and spider due to limitations in magnetic material, coil technology, thermal dissipation and adhesive properties. Additionally, the high aspect ratio of the cone assembly (i.e. radiation surface) also presents problems with acoustic loading and can be prone to rocking at high excursions (which, due to their long excursion stroke, create high internal enclosure pressures), typically along the longer axis of the driver.

There is often insufficient space to fit a circular spider, and therefore, the most robust design of spider (suspension element)-typically a textile spider, metal, or engineering plastics spring-is usually preferred for such a narrow form factor driver with extended excursion stroke.

In addition, the depth of the driver must be more controlled to avoid exacerbating rocking modes that could cause voice coil to contact motor parts, and to ensure the driver is kept at minimum possible design depth. The spider or suspension element must incorporate a certain width design in the system for the driver to perform the necessary long stroke.

### SUMMARY OF THE INVENTION

The present invention was developed in an attempt to provide an improved design with a high-aspect ratio suspension.

According to the present invention in a first aspect there is provided a loudspeaker comprising a chassis, a cup, a voice coil and a spider, wherein the outer edge of the spider is provided towards the bottom end of the cup and the inner edge of the spider is connected to a U-iron or T-yoke, the cup having a top end directly faces a diaphragm, and wherein the chassis includes at least one opening in a side wall, exposing a portion of the bottom end of the cup

Due to the opening or openings in the chassis, the stroke of the cup and voice coil is increased, and the stability of the voice coil is further enhanced. Thus, for a limited size of enclosure/chassis, greater performance can be achieved due to this longer stroke design. This therefore enables improved performance in a relatively small device, particularly bass performance. Thus, no subwoofer would often be necessary.

Preferably, the cup is a truncated cone having a tapered wall portion from a larger bottom to a smaller top end, and wherein the chassis includes at least one opening in a side wall, whereby a portion of the bottom end of the cup is located within the opening, or flush within the opening or protruding outwardly therefrom, such that the cup can move longitudinally relative to the chassis and with its bottom end moving within the longitudinal extent of the opening.

This enables the cup to be larger than would be possible otherwise, allowing for greater stroke of the voice coil.

Preferably, at least two openings are provided at respective opposing sides of the chassis.

Thus, the diameter of the bottom end of the cup and the cup itself can be greater, thus also improving the performance within a limited size chassis. It is not entirely constrained by the wall dimensions of the chassis, as in previously available devices.

Preferably, the top end of the cup has a flat annular surface.

One or more recessions may be provided in the cup's side surface.

The flat annular surface of the top end may be provided with one or more first recessions, preferably at least two first recessions, in diametrically opposed position.

The side surface of the cup may further have one or more second recessions, preferably two opposed second recessions, in diametrically opposed position.

The recessions allow moving suspension and/or other elements to be as close as possible to the outer housing of the product, again serving to maximise the stroke of the voice coil in a relatively small housing or product.

Preferably, the spider has an inner edge which is connected to a U-iron/T-yoke of the speaker and an outer edge which is connected to an inner surface of the bottom end of the cup.

Preferably, the outer edge of the spider comprises an extending portion which wraps around a bottom end of the cup.

The openings of the chassis have length D which enables the maximum moving stroke required by the voice coil. As the size/area of the spider increases, the audio performance of the loudspeaker becomes more stable, thus improving the performance within a limited size chassis. It is therefore not entirely constrained by the wall dimensions of the chassis, and the area of the spider can be larger than would be possible with a chassis without the openings. That is, the outer diameters of the cup and the spider can be maximized within a limited-size chassis, while still allowing a desired long excursion.

### BRIEF DESCRIPTION OF THE DRAWINGS

Embodiments of the invention will now be described, by way of example only, with reference to the accompanying drawings in which:

FIG. 1 shows a partially cutaway view of a loudspeaker;

FIG. 2 shows a plan view of a loudspeaker;

FIG. 3 shows a plan view of an alternative loudspeaker

FIG. 4 shows a cross-sectional view;

FIG. 5 shows an alternative design;

FIG. 6 shows an alternative design;

FIG. 7 shows an alternative design;

FIG. 8 shows a design with a non-circular spider;

FIG. 9 shows a ‘racetrack’ spider;

FIG. 10 shows a further alternative design; and

FIG. 11 shows a partial cross-section showing an opening in a chassis side wall and a cup.

### DETAILED DESCRIPTION

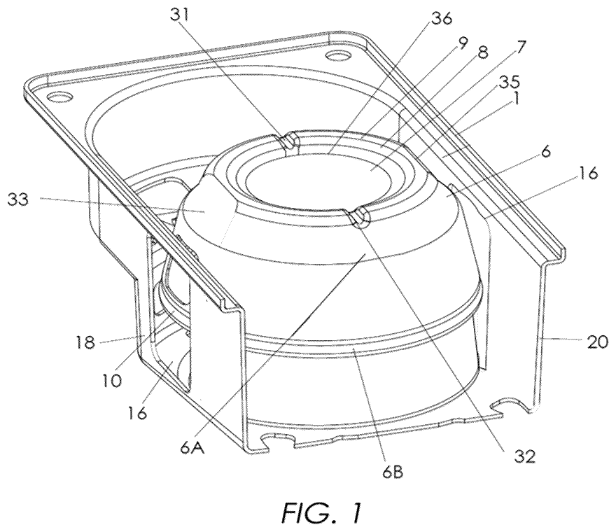

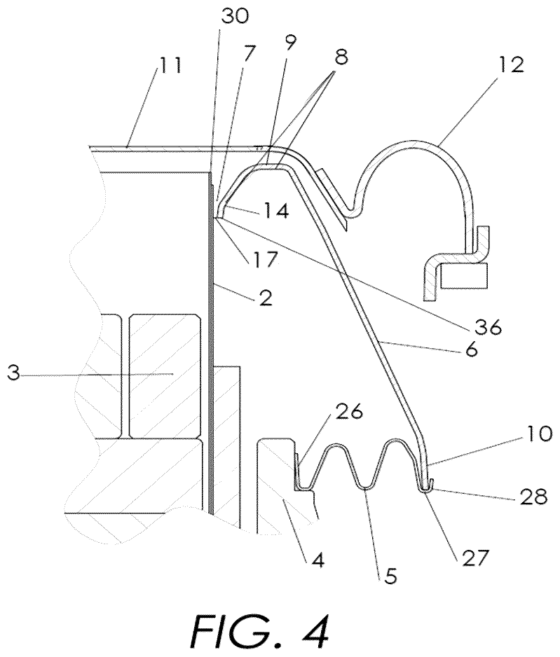

Referring to FIGS. 1 and 4, a loudspeaker comprises a chassis 1, in which speaker components including a voice coil 2, a cooper ring 3 and a U-iron (or T-yoke) 4 are mounted. Other components are, of course, included, as will be apparent to those skilled in the art.

A spider (suspension element) 5 is mounted between the U-iron (or T-yoke) 4 and the bottom end 10 of a cup 6. The cup 6 is generally in the form of a truncated cone, as shown most clearly in FIG. 1, and has a through hole 7 at its top end 9. The cup 6 features a tapered wall portion, with the perimeter of the bottom end larger than that at the top end. In the design shown, the cup 6 has an upper part 6A subtending one angle, and a bottom part 6B which may have a different conical angle, or be cylindrical. However, this may vary, and in some embodiments, the cup 6 may be a cone with a single conical angle from bottom to top.

The through hole 7 is circular and located at the center of the top end 9 of the cup 6. The cup 6 has an extending inner lip 8 extending downwardly from the through-hole at the top towards the bottom. That is the upper end of the chassis 1 may be bent or folded downwards, with this folded end (the extending inner lip 8) connected to the voice coil 2. The downwardly extending inner lip 8 is angled so as to protrude inwardly towards a longitudinal axis of the cup 6. The top end 9 of the cup 6 which is distal to the bottom end 10 which is connected to the spider 5. The spider is angled inwards (towards the longitudinal axis of the cup 6) in the embodiment, as shown in FIGS. 1 and 4 for example. The top end 9 of the cup 6 (which has the smaller diameter part of the truncated cone) is generally flat and connected to a diaphragm 11. The upper surface of the top end 9 is preferably an annular flat surface directly facing the diaphragm. The upper surface may lie at generally 90 degrees to the longitudinal axis of the cup 6. The top end 9 of the cup 6 may have a wholly or partially flat surface, wherein the flat surface is in a plane perpendicular to the longitudinal axis of the cup 6.

FIG. 4 also shows a surround ring 12 which is connected to the diaphragm 11. In use, of course, the voice coil 2 is within a magnetic field and moves in 20 accordance with a driving signal, in order to cause movement of the diaphragm 11, leading to the emission of sound.

The truncated cone cup 6 is mounted over the voice coil 2 and the spider 5. The through hole 7 is central to the upper part 6A of the cup 6. In use, at least a portion of the top end 30 of the voice coil 2 can protrude through the through hole 25 7, at least through the part of the through hole 7 defined by the radially inner end 14 of the downwardly extending inner lip 8. That is the voice coil 2 is connected to the cup 6 at a rim 36 of the through hole 7.

In FIG. 4, the voice coil 2 is connected to the extending inner lip 8 of the cup 6 via adhesive 17. The spider 5 is provided towards one longitudinal end of the cup 6 and at the other longitudinal end of the cup 6 there is provided the through hole 7, and the rim 36 of the extending inner lip 8 is connected to the upper portion of the voice coil 2. The voice coil 2, the spider 5 and at least a portion of the cup are disposed within the chassis 1.

The top end 9 of the upper part 6A of the cup 6 (i.e. the part distal from the bottom end 10 connected to the spider 5) is an annular flat surface and is connected to the diaphragm 11, wherein the annular flat surface is in a plane perpendicular to the elongate axis of the cup 6. Thus, when the voice coil 2 moves up and down (as shown in the FIGS. 1 and 4) it causes corresponding movement of the cup 6 and movement of the diaphragm 11. In this embodiment, when the voice coil 2 is in a static state, the voice coil 2 is not in contact with the diaphragm 11. That is, there is a gap between the top end 30 of the voice coil 2 and the bottom surface of the diaphragm 11. In another embodiment, the cup 6 does not necessarily need to have a through hole; the top end 30 of the voice coil 2 can be directly connected to the inner surface of the top end 9 of the cup 6.

Other parts in FIGS. 1 and 4 are other standard parts of a loudspeaker mechanism which will not be further described for clarity but would be understood by those skilled in the art.

As the voice coil 2 protrudes the through hole 7 in the cup 6, a greater stroke is enabled. Consequently, for a given size of the chassis 1, better performance can be achieved due to this longer stroke design. This results in improved performance in a relatively small device, particularly in terms of bass performance. Thus, no subwoofer would often be necessary.

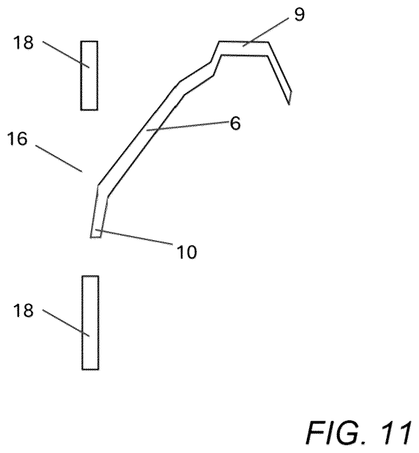

Further, in order to effectively “squeeze” a large a speaker driver assembly into a small a chassis as possible, the chassis 1 is provided with one or more openings 16. In the version shown in FIG. 1, there are two openings 16 in the opposite side walls 18 and f of the chassis 1. These two openings 16, or windows/cutouts, in the chassis 1 enable a portion of the bottom end 10 of the cup 6 to extend within, up to (tangentially align with), or beyond the plane of the side walls 18 and 20, as shown in FIG. 11. That is a portion of the bottom end 10 of the cup 6 lies flush with the opening 16, lies within the opening 16 or protrudes outwardly therefrom, such that the cup 6 can move longitudinally relative to the chassis 1 and with its bottom end 10 moving within the longitudinal extent of the opening 16. Thus, the diameter of the bottom end 10 of the cup 6 can be maximized and therefore the size of the cup 6 and the spider 5 can be greater accordingly.

The openings 16 have a length, which enables the maximum moving stroke required by the voice coil 2. As the size/area of the spider 5 increases, the audio performance of the loudspeaker becomes more stable, thus improving the performance within a limited size chassis. It is therefore not entirely constrained by the wall dimensions of the chassis 1, and the area of the spider 5 can be larger than would be possible with a chassis without the openings 16. That is, the outer diameters of the cup 6 and the spider 5 can be maximized within a limited-size chassis, while still allowing a desired long excursion.

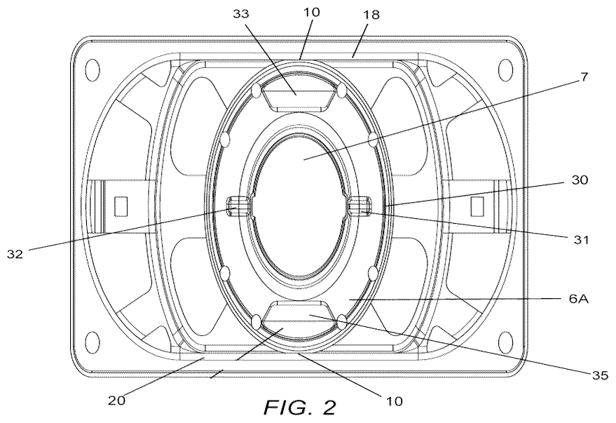

As is shown most clearly in FIG. 1 and FIG. 11, the bottom end 10 of the cup 6 lies partly within the openings 16, and the bottom end 10 is circular (or oval-shaped, see FIG. 2). In another embodiment, the bottom end 10 can extend slightly beyond the wall 18 and 20. Each opening 16 has a height such that the bottom end 10 of the cup 6 can move longitudinally up and down by a maximum distance within the opening 16.

Thus, in one embodiment as shown in FIG. 2, the cup 6 does not need be circular in cross-section but instead can be oval shape or elliptical shape. This top view also shows how in the region of the opening 16 under edge parts of the side walls 18 and 20, the bottom end 10 of the cup 6 extend into the opening 16 within the side wall 18 and 20 or slightly beyond it (for example, part of the edge of bottom end 10 is obscured by the side walls 18 and 20.). Also, the cup 6 may be of other shapes, and the shape of the spider 5 will also be designed to correspondingly match the shape of the cup 6.

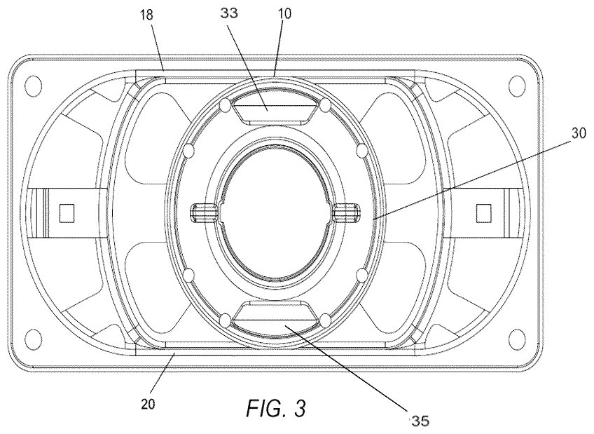

FIG. 3 shows a view of a design similar to that in FIG. 1 where the cup 6 is circular in cross-section. It will also be seen how the bottom end 10 of the cup 6 extends into the opening 16 in the side walls 18 and 20 (For example, part of the edge of bottom end 10 is obscured by side walls 18 and 20).

Other shapes or form-factors of a chassis 1 or housing/case may of course be used in embodiments of the invention.

The provision of the opening 16, enabling a wider cup to be used than before without contacting the side walls 18 and 20 of the chassis 1, allows a significantly larger cup and spider to be used, improving performance and enabling a more powerful driver to be used in a restricted size chassis. This is especially desirable in small form-factor designs, or items such as ‘smart/thin speakers’, Bluetooth™ or WiFi™ devices which are usually compact but required to provide as full sound as possible.

Referring to FIG. 4, the inner edge 26 of the spider 5 is connected to the U-iron (or T-yoke) 4 via adhesive, and the radially outer edge 27 of the spider 5 includes an extended portion 28. The extended portion 28 is generally a bent structure which wraps around at least a portion of the bottom end 10 of the cup 6. This allows the cup 6 to be securely fixed with the spider 5.

The top end 9 of the cup 6 is provided with one or more generally opposed first recessions 31 and 32, as shown in FIG. 1 and FIG. 2. Typically, the two recessions are mounted diametrically opposite each other, although there may be more or fewer. These are used to further bring moving suspension and/or other elements as close as possible to the outer housing of the product. Also, the first recesses 31 and 32 can be used to respectively place the voice coil 2's out-leads, allowing the two out-leads of the voice coil 2 to be respectively positioned between the first recesses 31 and 32 and the diaphragm 11, preventing them from moving out of place. Additional recessions may be provided towards the top surface of the cup 6, which may include diametrically opposed second recessions 33 and 35. The second recession 33 and 35 may be formed by two or more flat surfaces or by an arc-shaped surface. That is, each of the second recessions 33 and 35 is a generally multi-flattened part or arc-shaped part of the wall of the cup 6. Since the second recessions 33 and 35 are formed on a generally circular section body, they form two recesses located on both sides of the cup 6. Additionally, the second recessions 33 and 35 are located at parts of the cup 6 closest to the side walls 18 and 20 of the chassis 1. Basically, the size of the second recesses 33 and 35 is larger than that of the first recesses 31 and 32.

In a preferred embodiment, most clearly shown in FIG. 4, the diaphragm 11 is attached to the underside of an inner edge of the surround ring 12, typically using adhesive.

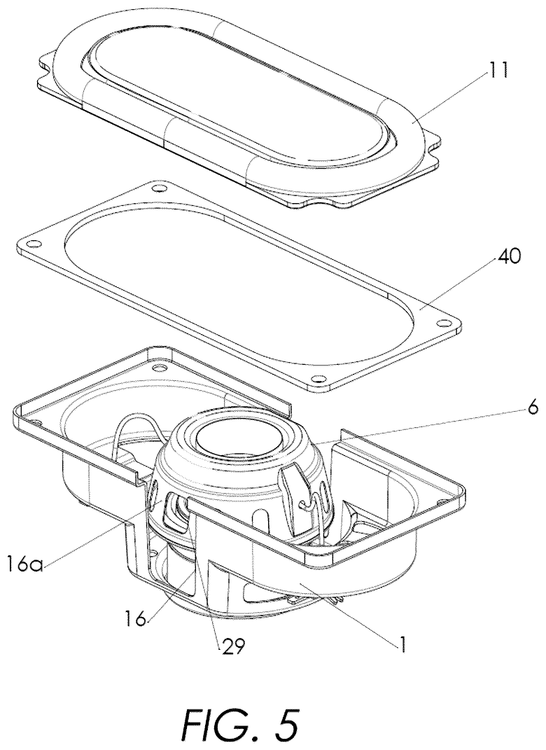

In an alternative embodiment shown in FIG. 5, the openings 16 in the side wall of the chassis 1 extend to the top of the chassis 1. Thus, there is open end 16a at the top of the opening 16. That is, compared to the embodiment of FIG. 1 where the opening 16 is a through-hole on the chassis 1, the opening 16 in this embodiment is an upward-facing recessed opening on the chassis 1. A diaphragm positioning ring 40 may then in some cases be mounted between the top of the chassis 1 (including open end 16a) and the diaphragm 11. Through the design of the openings 16 shown in FIG. 5, it maximises the moving height space and increases the stroke length of the cup 6 as well as the diaphragm 11. Additionally, as shown in FIG. 5, the cup 6 of this embodiment further includes at least one opening 29, with the opening 29 facing the opening 16 of the chassis 1 and being exposed from the opening 16. In one embodiment, multiple openings are formed in the wall of the cup 6 and are evenly distributed along the wall.

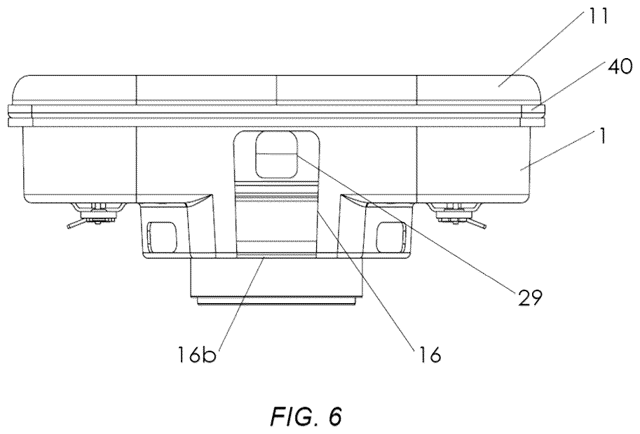

Alternatively, as seen in FIG. 6 the openings 16 extend down to the bottom end of the chassis 1. Thus, the openings 16 have lower open ends 16b at its bottom. That is, compared to the embodiment of FIG. 1 where the opening 6 is a through-hole on chassis 1, the opening 6 in this embodiment is a downward-facing recessed opening on the chassis 1. This again maximises the moving height space and therefore increases the stroke length of the cup 6 as well as the diaphragm 11. Also, as shown in FIG. 6, the cup 6 of this embodiment further includes at least one opening 29, with the opening 29 facing the opening 16 of the chassis 1 and being exposed from the opening 16.

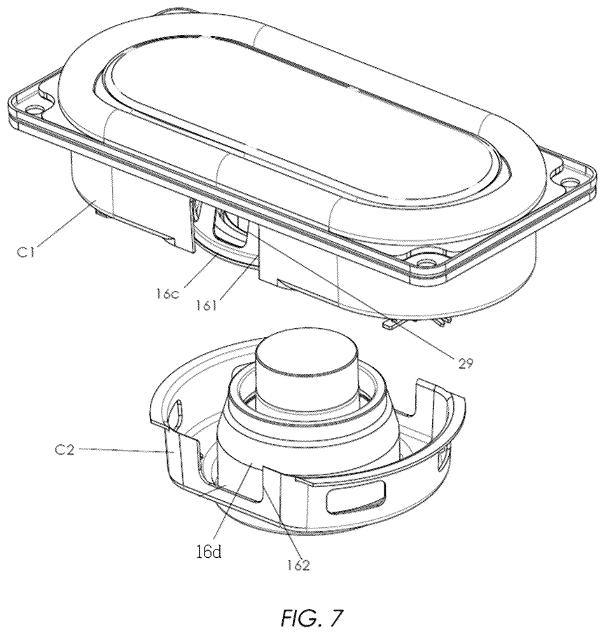

In a further variation shown in FIG. 7, the chassis 1 is formed in two parts or portions, an upper chassis part C1 and a lower chassis part C2. The upper chassis part C1 includes an upper opening 161 with lower open end 16c at its bottom and the lower chassis part C2 includes a lower opening 162 with upper open end 16d at its top. When joining the upper chassis part C1 and the lower chassis part C2, a single opening 16 is formed. That is, the chassis 1 has two different parts C1 and C2, with the upper opening 161 formed in the upper chassis part C1 and the lower opening 162 formed in the lower chassis part C2, which align to create a single opening 16. The two chassis parts may be formed separately or be parts of a single chassis. Also, as shown in FIG. 7, the cup 6 of this embodiment further includes at least one opening 29, with the opening 29 facing the opening 16 of the chassis 1 and being exposed through the opening 16.

Clearly, in the above and other embodiments, openings (or windows) 16 will be formed on two sides of the chassis 1, opposite to each other. However, there may be more than two or fewer.

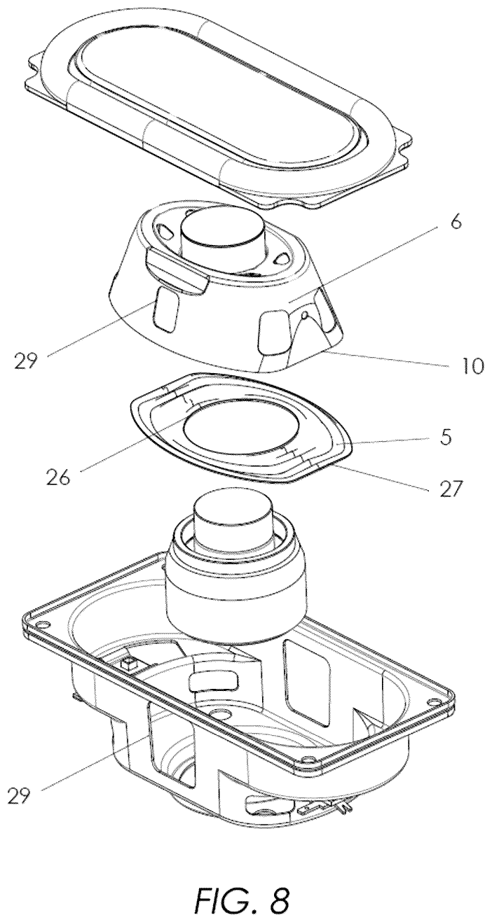

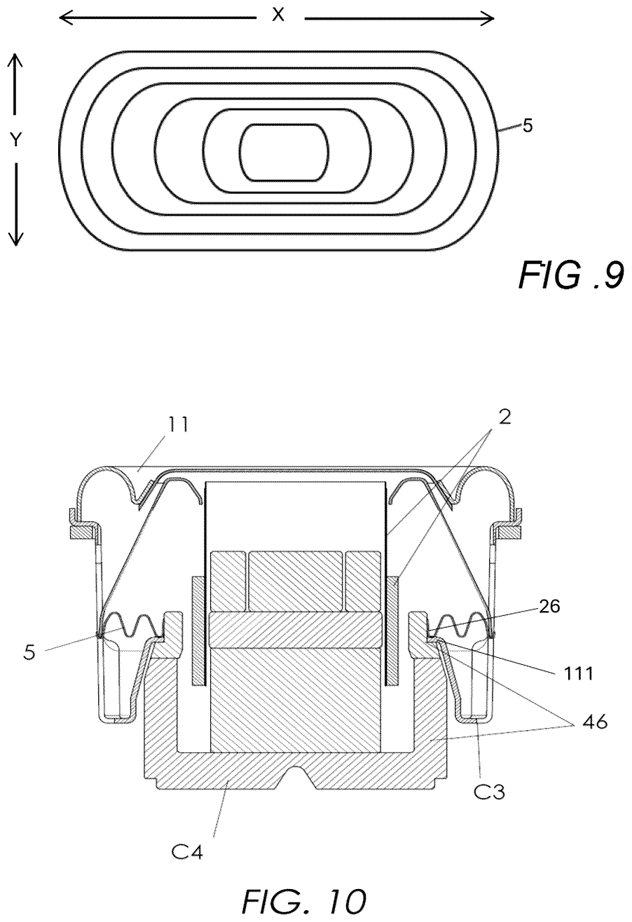

In another variation, as shown in FIGS. 8 and 9, the spider 5, instead of being circular as is traditional, has a different configuration, with, for example a length (e.g. in the X direction of FIG. 9) that is longer than its width (e.g. in the Y direction of FIG. 9). The outermost and inner corrugations of the spider 5 may be formed in a racetrack or elliptical pattern as shown in FIGS. 8 and 9.

That is, the spider 5 has a shape that is in a generally racetrack or elliptical pattern, close to a rectangular shape (see FIG. 9). The aspect ratio between its length and width may typically be between 1.3 and 2.2 for example. This helps to fit into a restricted-size speaker chassis/enclosure whilst maximising the stability performance of the voice coil and the spider. Furthermore, the bottom opening of the bottom end 10 of the cup 6 also matches the shape of the outer edge 27 of the spider 5 (e.g. racetrack shape), thus the cup 6 also accordingly taking on a racetrack or elliptical cone configuration for example. Specifically, the shape and size of the bottom opening of the bottom end 10 of the cup 6 will generally match the shape and size of the outer edge 27 of the spider 5. This allows the bottom end 10 of the cup 6 to be joined with the outer edge 27 of the spider 5, as shown in FIG. 4. This spider shape design increases the overall stability of the voice coil 2. Additionally, the cup 6 has multiple openings 29 around its sidewall, with at least one opening 29 being exposed through the opening 16 of the chassis 1. In one embodiment, the multiple openings 29 are formed in the wall of the cup 6 and are evenly distributed along the wall.

In another variation, as shown in FIG. 10, the bottom of the chassis 1 may be folded back and bonded to the spider 5 and T-yoke 46. Specifically, the bottom end C3 of the chassis 1 may be bent or folded upwards, with this folded end 111 connected to the inner edge 26 of the spider 5 and the upper end of a T-yoke 46. Further, the folded end 111 is positioned between the inner edge 26 and the T-yoke 46. Unlike other embodiments, in this embodiment, the bottom end of the chassis 1 does not wrap around or surround the bottom C4 of the T-Yoke 46. Instead, it connects to the upper end of the T-yoke 46, leaving the bottom C4 of the T-Yoke 46 exposed from the bottom end C3 of the chassis 1. A T-yoke is present in most loudspeakers and serves to conduct magnetism when electrified. Any feature in any embodiment or variation shown or described may of course be used in other embodiments.

Note that in this specification the relative terms “upper”, “bottom”, “top”, etc refer to a configuration in which the diaphragm is generally at the top vertically. In practice, of course the loudspeaker will be in any disposition, dependent upon the external design, use of the loudspeaker, and personal choice for example.

It will be appreciated that the embodiments described are examples only and changes may of course be made which are within the scope of the present invention.

1. A loudspeaker comprising
a chassis,
a cup having a top end directly facing a diaphragm and a bottom end, at least a portion of the cup being disposed in the chassis;
a voice coil disposed in the chassis; and
a spider disposed within the chassis and comprising:
an outer edge provided towards the bottom end of the cup; and
an inner edge connect to a U-iron or T-yoke;
wherein the chassis includes at least one opening in a side wall, exposing a portion of the bottom end of the cup.

2. A loudspeaker as claimed in claim 1, wherein the cup is at least partially formed as a truncated cone having a tapered wall portion from a larger bottom end to a smaller top end.

3. A loudspeaker as claimed in claim 1, wherein a portion of the bottom end of the cup lies flush with the opening or lies within the opening or protrudes outwardly therefrom, such that the cup can move longitudinally relative to the chassis and with its bottom end moving within the longitudinal extent of the opening.

4. A loudspeaker as claimed in claim 3, wherein there are at least two openings, provided at respective opposing side walls of the chassis.

5. A loudspeaker as claimed in claim 1, wherein the voice coil does not come into contact with the diaphragm, whereby there is a gap between the top end of the voice coil and the diaphragm.

6. A loudspeaker as claimed in claim 3, wherein the openings extend to the top of the chassis.

7. A loudspeaker as claimed in claim 1, further comprising a diaphragm positioning ring disposed between the diaphragm and the chassis.

8. A loudspeaker as claimed in claim 3, wherein the openings extend to the bottom of the chassis.

9. A loudspeaker as claimed in claim 1, wherein the chassis has two parts, with an upper opening formed in an upper chassis part and a lower opening formed in a lower chassis part, which upper and lower openings align to create a single opening.

10. A loudspeaker as claimed in claim 1, wherein the top end of the cup has a wholly or partially flat surface.

11. A loudspeaker as claimed in claim 10, wherein the flat surface is in a plane perpendicular to the elongate axis of the cup.

12. A loudspeaker as claimed in claim 1, further comprising one or more recessions in the surface of the cup.

13. A loudspeaker as claimed in claim 12, wherein the top surface of the cup is provided with one or more first recessions.

14. A loudspeaker as claimed in claim 13, further comprising at least two first recessions, in diametrically opposed position,
wherein at least two out-leads of the voice coil to be respectively positioned between the first recesses and the diaphragm, preventing them from moving out of place.

15. A loudspeaker as claimed in claim 1, wherein the side surface of the cup has one or more second recessions.

16. A loudspeaker as claimed in claim 15, wherein there are two diametrically opposed second recessions, and the second recessions are located at parts of the cup to be closest to the side walls of the chassis.

17. A loudspeaker as claimed in claim 15, wherein each second recession is a generally multi-flattened part or arc-shaped part of the wall of the cup.

18. A loudspeaker as claimed in claim 1, wherein at the upper end of the cup there is provided a through hole, such that the top end of the voice coil protrudes into or through the through hole, and the voice coil is connected to the cup at a rim of the through hole.

19. A loudspeaker as claimed in claim 18, wherein the top end of the cup has a flat annular surface which surrounds the through hole and is connected to the diaphragm.

20. A loudspeaker as claimed in claim 18, wherein the chassis comprises a downwardly extending inner lip extending from the through-hole at the top towards the bottom.

21. A loudspeaker as claimed in claim 20, wherein the downwardly extending inner lip is angled so as to protrude inwardly towards a longitudinal axis of the cup.

22. A loudspeaker as claimed in claim 11, wherein the outer edge of the spider is connected to an inner surface of the bottom end of the cup.

23. A loudspeaker as claimed in claim 23, wherein the outer edge of the spider comprises an extending portion which wraps around the bottom end of the cup.

24. A loudspeaker as claimed in claim 18, wherein the voice coil is adhesively connected to the cup at the rim of the through hole.

25. A loudspeaker as claimed in claim 1, further comprising at least one opening in the wall of the cup which faces the opening on the side wall of the chassis and is exposed from the opening of the chassis.

26. A loudspeaker as claimed in claim 25, further comprising a plurality of openings in the wall of the cup which are evenly distributed along the wall of the cup.

27. A loudspeaker as claimed in claim 1, further comprising a diaphragm positioning ring between the top of the chassis and the diaphragm.

28. A loudspeaker as claimed in claim 1, wherein the spider is non-circular, and has a length and a width, wherein the aspect ratio between the length and width is between 1.3 and 2.2.

29. A loudspeaker as claimed in claim 28, wherein the spider has a generally elliptical configuration.

30. A loudspeaker as claimed in claim 1, wherein the chassis has a bottom end which is bent upwards, whereby it connects to both an inner edge of the spider and an upper end of the U-iron or T-Yoke.
